(19) United States
(12) Patent Application Publication
(10) Pub. No.: US 2025/0095942 A1
(43) Pub. Date: Mar. 20, 2025

(54) BATTERY OVERCURRENT CUTOFF DEVICE

(71) Applicants: Hyundai Motor Company, Seoul (KR); Kia Corporation, Seoul (KR); Chang Hwan Precision Terminal Co., Ltd., Yongin (KR)

(72) Inventors: Jong Gu Kim, Hwaseong (KR); Hawn Chang Kim, Yongsin (KR)

(21) Appl. No.: 18/811,347

(22) Filed: Aug. 21, 2024

(30) Foreign Application Priority Data
Sep. 18, 2023 (KR) 10-2023-0123941

(51) Int. Cl. H01H 85/08; H01H 85/02; H01H 85/06

(52) U.S. Cl. CPC H01H 85/08; H01H 85/0241; H01H 85/06; H01H 2085/0266; H01H 2231/026

(57) ABSTRACT

Provided is a battery overcurrent cutoff device designed for vehicles, incorporating either a high current busbar within an intelligent battery sensor (IBS) or a high current terminal. This device features a connecting portion divided into first and second segments, and a breaking portion positioned between them. The breaking portion is engineered to sever within a specified time range upon detecting overcurrent, using materials like copper-nickel, iron-nickel, and other alloys. It may include design elements such as grooves, through-holes, and flexible joints to enhance functionality and durability. Additionally, tin plating is used to improve conductivity and corrosion resistance. The device can also include temperature monitoring and heat-resistant insulating materials to ensure safety and reliability.

### CROSS-REFERENCE TO RELATED APPLICATION

This application claims under 35 U.S.C. § 119 (a) the benefit of Korean Patent Application No. 10-2023-0123941, filed on Sep. 18, 2023, which is hereby incorporated by reference as if fully set forth herein.

### BACKGROUND

### Technical Field

The present disclosure pertains to a battery overcurrent cutoff device designed for vehicles. This device features either a high current busbar within an intelligent battery sensor (IBS) or a high current terminal. It may include a connecting portion divided into first and second segments, with a breaking portion positioned between them. The breaking portion is engineered to sever within a specified time range upon detecting overcurrent, utilizing materials such as copper-nickel, iron-nickel, and other alloys. Design elements like grooves, through-holes, and flexible joints are incorporated to enhance functionality and durability. Additionally, the breaking portion may be tin-plated to improve conductivity and corrosion resistance. The device can also include a temperature sensor to monitor the breaking portion and grooves filled with heat-resistant insulating materials, ensuring safety and reliability. This innovative device aims to improve the safety, reliability, and efficiency of battery systems in automotive applications by effectively managing electrical faults.

### Background

Currently, a lead-acid battery, among various types of batteries, is used for a vehicle with an internal combustion engine to start the engine.

The lead-acid battery used for the vehicle uses a starter motor to start the engine, and the starter motor uses a high-current cable for positive and negative electrodes due to the great current consumption.

Recently, an intelligent battery sensor (IBS) that monitors the state of the lead-acid battery of the vehicle is installed at a negative electrode of the lead-acid battery to monitor the state of the lead-acid battery. In the past, because there was no desirable protection device in case of an overcurrent flowing in the lead-acid battery, a typical method of increasing the square (SQ)) of a high-current cable that grounds a negative electrode of the lead-acid battery and a vehicle body and preventing damage to an IBS circuit due to a short was mainly used.

However, in this case, increasing the SQ of the high-current cable may increase the cost of the vehicle, and there is thus a need for a solution to this problem.

The preceding description of the related art is intended to provide a better understanding of the background of the present disclosure and should not be taken as an admission of the related art known to those of ordinary skill in the art. cl SUMMARY OF THE PRESENT DISCLOSURE

An object of the present disclosure is to provide a battery overcurrent cutoff device having a high current busbar or a high current terminal adapted to short-circuit within a predetermined time period when an abnormal overcurrent flows in a lead-acid battery.

In some embodiments, a battery overcurrent cutoff device for vehicles comprises a high current busbar provided in an intelligent battery sensor (IBS) or a high current terminal. This device includes a connecting portion with first and second segments and a breaking portion positioned between them, configured to break within a predetermined time period in response to an overcurrent flow. The breaking portion may be made from alloys such as copper-nickel, iron-nickel, chromium-nickel, and copper-nickel-manganese, while the connecting portion may comprise copper or aluminum. The predetermined time period for the breaking portion to respond may range between 1.5 seconds and 5 seconds. Additionally, the breaking portion may be thinner than the connecting portion.

The breaking portion may feature a first and second breaking portion arranged serially, or grooves extending along its width, which can cross or face each other. The first connecting portion may include at least one bolt coupling hole, while the second connecting portion may have a cable fixing portion.

In some embodiments, a vehicle comprising the battery overcurrent cutoff device includes similar features and materials. The breaking portion in the device may have through-holes arranged in parallel along its width.

Further embodiments of the battery overcurrent cutoff device may involve a breaking portion plated with tin to enhance electrical conductivity and corrosion resistance, and may include grooves filled with heat-resistant insulating material. The device may also incorporate a temperature sensor to monitor the breaking portion's temperature or a flexible joint to handle mechanical stresses and vibrations.

The battery overcurrent cutoff device according to embodiments of the present disclosure described herein may automatically cut a short circuit off within a predetermined time period when the short circuit occurs due to an overcurrent flowing in a high current circuit and may thereby prevent damage to a device such as an intelligent battery sensor (IBS).

In addition, there is no need to increase the square (SQ) of a high-current cable to prevent a short circuit due to an overcurrent, and thus a cost reduction effect may be achieved.

The effects that can be achieved from the present disclosure are not limited to those described above, and other effects not described above may also be clearly understood by those skilled in the art from the following description.

### BRIEF DESCRIPTION OF THE DRAWINGS

FIG. 1 is a diagram illustrating a battery overcurrent cutoff device according to an embodiment of the present disclosure.

FIG. 2 is a diagram illustrating a high current busbar in a battery overcurrent cutoff device according to an embodiment of the present disclosure.

FIG. 3 is a diagram illustrating a high current busbar installed on an intelligent battery sensor (IBS) in a battery overcurrent cutoff device according to an embodiment of the present disclosure.

FIG. 4 is a diagram illustrating various examples of a shape of a breaking portion that facilitates the interruption of a current flow in a high current busbar in a battery overcurrent cutoff device according to an embodiment of the present disclosure.

FIG. 5 is a diagram illustrating a high current terminal in a battery overcurrent cutoff device according to an embodiment of the present disclosure.

FIG. 6A and FIG. 6B are diagrams illustrating various examples of a shape of a breaking portion that facilitates the interruption of a current flow in a high current terminal in a battery overcurrent cutoff device according to an embodiment of the present disclosure.

FIG. 6A is a diagram illustrating a parallel current flow setup with a centrally located, uniform through-hole in the breaking portion.

FIG. 6B is a diagram illustrating a serial current flow setup with a through-hole that varies in width, paired with a reversed matching through-hole.

### DETAILED DESCRIPTION OF THE DISCLOSURE

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

In the description of the embodiments, when an element is described as formed “above/on” or “below/under” another element, it may be construed that they are in direct contact, or they are in indirect contact with one or more other elements interposed therebetween. In this case, the use of “above/on” or “below/under” may be based on what is shown in the accompanying drawings, and these terms are used only to indicate a relative positional relationship between elements for the convenience of description but may not be used to limit the actual positions of the elements. For example, “B above/on A” is intended only to indicate that B is shown above/on A in the drawings, unless otherwise stated or unless the properties of A or B require that A be located above/on B. In actual implementations, B may be located below/under A, or B and A may be disposed in parallel.

In addition, the thickness or size of each layer (film), region, pattern, or structure in the drawings does not necessarily indicate the actual size, as it may be modified for clarity and convenience of description.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, embodiments will be described in detail with reference to the accompanying drawings, but the same or corresponding components are assigned the same reference numerals regardless of the drawings, and the repeated description thereof will be omitted.

A battery overcurrent cutoff device 100, which is adapted to electrically connect a negative terminal of a battery to a vehicle body and disconnect them in the event of an overcurrent, may include at least one of a high current busbar 120 provided in an intelligent battery sensor (IBS) 110, and a high current terminal 220.

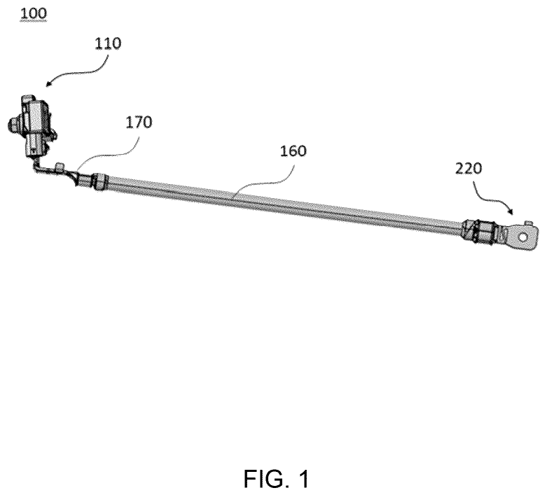

Although FIG. 1 illustrates the battery overcurrent cutoff device 100 in which the IBS 110 provided with the high current busbar 120, and the high current terminal 220, are provided at both ends of a cable 160, examples are not limited thereto. For example, the battery overcurrent cutoff device 100 may only have the IBS 110 with the high current busbar 120 or may only have the high current terminal 220 to cut an overcurrent off.

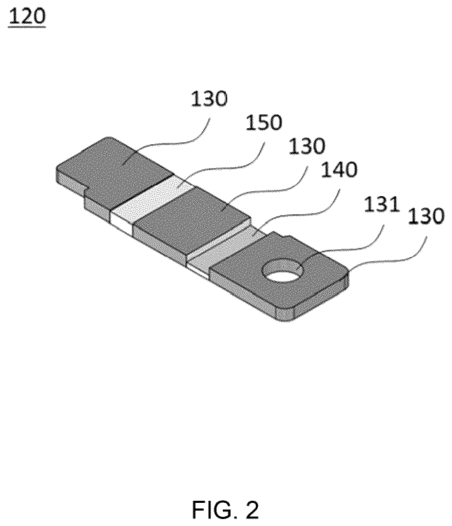

Hereinafter, the high current busbar 120, according to an embodiment of the present disclosure, will be first described with reference to FIGS. 2 through 4.

According to an embodiment, the high current busbar 120 may include a connecting portion 130 and a breaking portion.

Referring to FIG. 2, the connecting portion 130 may be provided in the form of a plate elongated in a longitudinal direction and may be formed of at least one of copper and aluminum.

The breaking portion may be provided between portions of the connection portion 130, and may break within a predetermined time period in case of an overcurrent. The predetermined time period may be herein between 1.5 seconds and 5 seconds.

Of typical types of battery applied to vehicles, a lead-acid battery may consume current the most when a starter motor is activated to start a vehicle.

However, since the starter motor operates in a very short period of time, it is desirable to ensure that the lead-acid battery breaks if current flows for an abnormally long period of time.

Therefore, the predetermined time period may desirably be in a range of approximately 1.5 seconds to 5 seconds.

Specifically, the breaking portion may be formed with a thickness less than that of the connecting portion 130 as shown in FIG. 2 to facilitate the breaking in case of an overcurrent.

The breaking portion may be formed with at least one alloy among copper-nickel, iron-nickel, chromium-nickel, and copper-nickel-manganese alloys. The breaking portion may be plated with tin.

According to an embodiment, the high current busbar 120 may include a plurality of breaking portions on the connecting portion 130 along a longitudinal direction, as shown in FIG. 2.

Specifically, the breaking portion may include a first breaking portion 140 and a second breaking portion 150. According to an embodiment, the first breaking portion 140 may be formed with a thickness less than that of the second breaking portion 150. This may allow the breaking portion to break before the overcurrent flows through a circuit in the event of a short, thereby protecting the circuit.

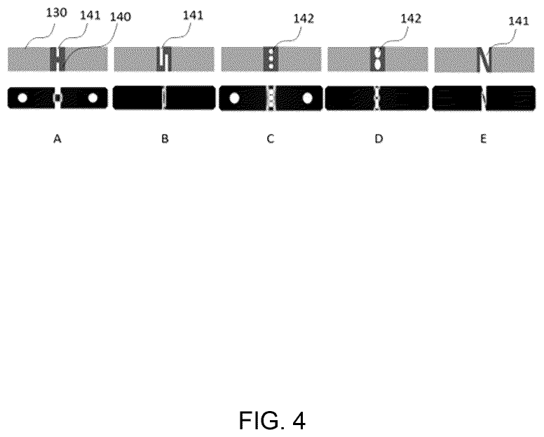

The first breaking portion 140 may have grooves 141 formed therein to facilitate the breaking upon a short. The grooves 141 may be formed to face each other inwardly in a width direction, as shown in A of FIG. 4, such that a portion of the first breaking portion 140 is formed to be narrower than the width of the connecting portion 130.

This shape may first interrupt a current flow when an overcurrent flows, to raise the temperature and facilitate the breaking in case of an overcurrent.

Alternatively, the grooves 141 may be formed inwardly in the width direction but formed to be alternately crossing with respect to each other, as shown in B of FIG. 4.

This shape may effectively interrupt a current flow as the distance along which the current flows increases in case of an overcurrent.

Alternatively, the grooves 141 may be formed such that the grooves 141 with pointed ends are alternately crossing, with the width narrowing inwardly, as shown in E of FIG. 4. This may allow a portion of the breaking portion to be diagonally connected to each other to achieve structural stability.

Alternatively, the first breaking portion 140 may have a through-hole 142 formed therein. The through-hole 142 may be provided as a plurality of through-holes in the width direction, as shown in C of FIG. 4.

For example, in a case where a plurality of circular through-holes 142 is formed in the width direction, the plurality of through-holes 142 may be connected to each other, which may have the same effect as the breaking portion connecting the connecting portion 130 therebetween in parallel.

This may contribute to geometrical stability, preventing impact-induced gaping.

Alternatively, the plurality of through-holes 142 may be elliptical in shape.

In this case, the plurality of through-holes 142 may be formed to be elliptical in the width direction, as shown in D of FIG. 4.

For example, in a case where a plurality of elliptical through-holes 142 are formed, it may be applicable when the length of a busbar is shorter, compared to the circular through-holes 142, and may achieve the same effect as the circular through-holes 142.

On one side of the connecting portion 130, a coupling hole 131 may be formed to allow a cable fixing portion 170 adapted to fix the cable 160 to be bolted thereto.

Also, on the other side of the connecting portion 130, an electrode connecting portion 180 adapted to be connected to a negative electrode may be welded thereto.

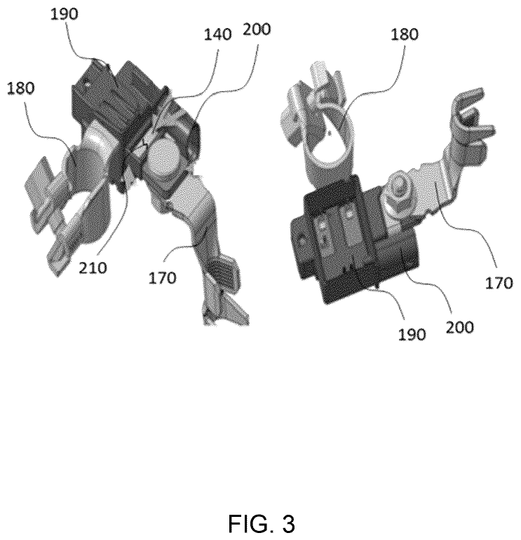

Referring to FIG. 3, the electrode connecting portion 180 and the cable fixing portion 170 may be installed to be orthogonal to each other when installed on the high current busbar 120.

This may allow the IBS 110 to be installed in a lead-acid battery without taking up much space.

The high current busbar 120 may be provided in the IBS 110 described above. The IBS 110 may include a housing 190.

The housing 190 may receive therein at least a portion of the circuit of the IBS 110 and the high current busbar 120, as shown in FIG. 3.

Specifically, the high current busbar 120 may be installed in the housing 190 such that one side of the connecting portion 130 in which the coupling hole 131 is formed is exposed to the outside.

On the housing 190, an inspection hole 210 may be formed through which the first breaking portion 140 is visible, as shown in FIG. 3.

Thus, in a case where the first breaking portion 140 breaks due to an overcurrent flowing in the high current busbar 120, such a breakage may be checked with the naked eye, facilitating easy diagnosis of a failure condition.

On the housing 190, a connector connecting portion 200 may be formed, as shown in FIG. 3.

According to an embodiment, the inspection hole 210 may have a cover formed of a transparent material to prevent foreign substances from entering the first breaking portion 140 and causing a short circuit.

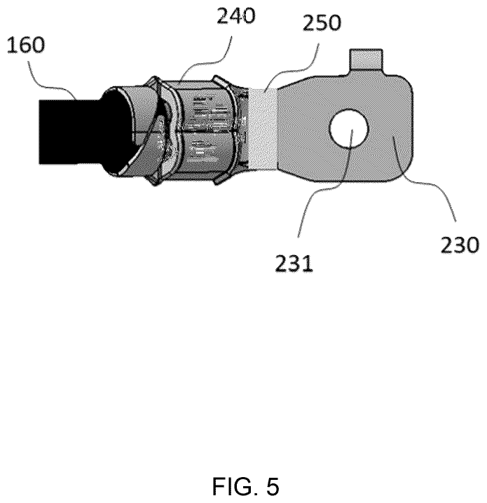

Hereinafter, the high current terminal 220, according to an embodiment of the present disclosure, will then be described with reference to FIG. 5.

According to an embodiment, the high current terminal 220 may include a connecting portion 230 and a breaking portion 250.

The connecting portion 230 may have at least one bolt coupling hole 231 formed on one side in a longitudinal direction and a cable connecting portion 240 formed on the other side in the longitudinal direction.

The connecting portion 230 may be formed of at least one of copper and aluminum, as in the high current busbar 120 described above.

The breaking portion 250 may be provided between the bolt coupling hole 231 and the cable connecting portion 240.

The breaking portion 250 may be formed of at least one alloy among copper-nickel, iron-nickel, chromium-nickel, and copper-nickel-manganese alloys, as in the high current busbar 120 described above.

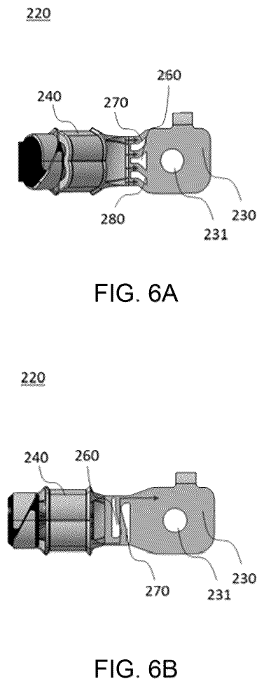

The breaking portion 250 may have a plurality of through-holes formed as shown in FIG. 6A and FIG. 6B to allow current to flow in parallel or in series.

For the parallel current flow, the through-holes formed in the breaking portion 250 may include a first through-hole 260 formed at the center, as shown in FIG. 6A.

A second through-hole 270 may be formed on one side of the first through-hole 260 in a width direction. A third through-hole 280 formed symmetrically with the second through-hole 270 may be formed on the other side of the first through-hole 260 in the width direction.

Thus, the current may be branched while flowing in a direction indicated by the red arrow, and an overcurrent may thereby flow to increase the temperature of the breaking portion 250 such that it breaks within a predetermined time period to protect the circuit.

Alternatively, for the serial current flow, the through-holes formed in the breaking portion 250 may include a first through-hole 260 having different widths on one side and the other side, and a second through-hole 270 having the same shape as the first through-hole 260 but formed in reverse, as shown in FIG. 6B.

Thus, the current may divert while flowing in a direction indicated by the red arrow, and an overcurrent may thereby flow to increase the temperature of the breaking portion 250 such that it breaks within a predetermined time period to protect the circuit.

While desirable embodiments of the present disclosure have been shown and described above, it will be apparent to one of ordinary skill in the art that various modifications or changes in form and details may be made in these embodiments without departing from the spirit and scope of the claims and their equivalents.

What is claimed is:

1. A battery overcurrent cutoff device for use in a vehicle, the battery overcurrent cutoff device comprising:
at least one of a high current busbar provided in an intelligent battery sensor (IBS), or a high current terminal,
wherein the at least one of the high current busbar or the high current terminal comprises:
a connecting portion comprising a first connecting portion and a second connecting portion; and
a breaking portion provided in-between the first and second connecting portions and configured to break within a predetermined time period in response to an overcurrent flow.

2. The battery overcurrent cutoff device of claim 1, wherein the breaking portion comprises at least one alloy among copper-nickel, iron-nickel, chromium-nickel, and copper-nickel-manganese alloys, and
the connecting portion comprises at least one of copper and aluminum.

3. The battery overcurrent cutoff device of claim 1, wherein the predetermined time period is between about 1.5 seconds and 5 seconds.

4. The battery overcurrent cutoff device of claim 1, wherein the breaking portion is thinner than the connecting portion.

5. The battery overcurrent cutoff device of claim 1, wherein the breaking portion comprises:
a first breaking portion and a second breaking portion, the first breaking portion and a second breaking portion arranged serially in-between the first and second connecting portions.

6. The battery overcurrent cutoff device of claim 1, wherein the breaking portion comprises:
a first groove extended along a width direction of the breaking portion; and
a second groove extended along the width direction.

7. The battery overcurrent cutoff device of claim 6, wherein the first groove extends from one of both ends along the width direction of the breaking portion and the second groove extends from the other one of the both ends.

8. The battery overcurrent cutoff device of claim 7, wherein the first groove and the second groove are formed to have ends facing each other.

9. The battery overcurrent cutoff device of claim 7, wherein the first groove and the second groove are formed to cross each other in a longitudinal direction of the breaking portion.

10. The battery overcurrent cutoff device of claim 1, wherein the first connecting portion comprises at least one bolt coupling hole and the second connecting portion comprises a cable fixing portion.

11. A vehicle comprising a battery overcurrent cutoff device for use in the vehicle, wherein the battery overcurrent cutoff device comprises:
at least one of a high current busbar provided in an intelligent battery sensor (IBS), or a high current terminal,
wherein the at least one of the high current busbar or the high current terminal comprises:
a connecting portion comprising a first connecting portion and a second connecting portion; and
a breaking portion provided in-between the first and second connecting portions and configured to break within a predetermined time period in response to an overcurrent flow.

12. The vehicle of claim 11, wherein the breaking portion comprises at least one alloy among copper-nickel, iron-nickel, chromium-nickel, and copper-nickel-manganese alloys, and
the connecting portion comprises at least one of copper and aluminum.

13. The vehicle of claim 11, wherein the predetermined time period is between about 1.5 seconds and 5 seconds.

14. The vehicle of claim 11, wherein the breaking portion is thinner than the connecting portion.

15. The vehicle of claim 11, wherein the breaking portion comprises:
a first breaking portion and a second breaking portion, the first breaking portion and a second breaking portion arranged serially in-between the first and second connecting portions.

16. The vehicle of claim 11, wherein the breaking portion has a plurality of through-holes arranged in a parallel manner along a width direction thereof.

17. A battery overcurrent cutoff device comprising:
at least one of a high current busbar provided in an intelligent battery sensor (IBS), or a high current terminal,
wherein the at least one of the high current busbar or the high current terminal comprises:
a connecting portion comprising a first connecting portion and a second connecting portion; and
a breaking portion provided in-between the first and second connecting portions and configured to break within a predetermined time period in response to an overcurrent flow, wherein the breaking portion is plated with tin to enhance electrical conductivity and corrosion resistance.

18. The battery overcurrent cutoff device of claim 17, wherein the breaking portion includes grooves filled with a heat-resistant insulating material.

19. The battery overcurrent cutoff device of claim 17, further comprising a temperature sensor configured to monitor the temperature of the breaking portion.

20. The battery overcurrent cutoff device of claim 17, wherein the breaking portion comprises a flexible joint to handle mechanical stresses and vibrations.
